(19) United States
(12) Patent Application Publication
(10) Pub. No.: US 2026/0239446 A1
(43) Pub. Date: Aug. 13, 2026

(54) INDICATING A TIMING ADVANCE GROUP

(71) Applicant: Nokia Technologies Oy, Espoo (FI)

(72) Inventors: Samuli Heikki TURTINEN, Oulu (FI); Chunli WU, Beijing (CN); Matha DEGHEL, Massy (FR); Timo KOSKELA, Oulu (FI)

(21) Appl. No.: 19/472,747

(22) PCT Filed: Apr. 6, 2023
(86) PCT No.: PCT/CN2023/086688

§ 371 Date: Oct. 6, 2025

(51) Int. Cl. H04W 74/0833; H04W 76/38

(52) U.S. Cl. CPC H04W 74/0833; H04W 76/38

(57) ABSTRACT

Embodiments of the present disclosure relate to devices, methods, apparatuses and computer readable storage media of indicating a Timing Advance Group (TAG). The method comprises receiving, at a terminal device and from a network device, a flag mappable to a timing advance group identity (TAG ID) associated with a serving cell of the terminal device during the random access procedure, wherein the terminal device is configured with two TAGs associated with the serving cell and the TAG ID is associated with one of the two TAGs; and determining the TAG ID at least based on a mapping between flag index values and TAG ID index values.

### FIELD

Embodiments of the present disclosure generally relate to the field of telecommunication and in particular to devices, methods, apparatuses and computer readable storage media of indicating a timing advance group (TAG).

### BACKGROUND

The main objectives for the Multiple Input Multiple Output (MIMO) enhancement may involve beam management, multiple transmission and reception point (mTRP) for ultra-reliable, low-latency communication (URLLC), mTRP for enhanced mobile broadband (eMBB) and Time Division Duplexing (TDD)/Frequency Division Duplexing (FDD) reciprocity.

### Summary

In a first aspect, there is provided an apparatus. The apparatus comprises at least one processor; and at least one memory storing instructions that, when executed by the at least one processor, cause the apparatus at least to receive, during the random access procedure, a flag mappable to a timing advance group identity (TAG ID) associated with a serving cell of the apparatus, wherein the apparatus is configured with two TAGs associated with the serving cell and the TAG ID is associated with one of the two TAGs; and determine the TAG ID at least based on a mapping between flag index values and TAG ID index values.

In a second aspect, there is provided an apparatus. The apparatus comprises at least one processor; and at least one memory storing instructions that, when executed by the at least one processor, cause the apparatus at least to transmit, to the terminal device and during the random access procedure, a flag mappable to a TAG ID associated with a serving cell of the apparatus, wherein the terminal device is configured with two TAGs associated with the serving cell and the TAG ID is associated with one of the two TAGs.

In a third aspect, there is provide a method. The method comprises receiving, at a terminal device and from a network device, a flag mappable to a timing advance group identity, TAG ID, associated with a serving cell of the terminal device during the random access procedure, wherein the terminal device is configured with two TAGs associated with the serving cell and the TAG ID is associated with one of the two TAGs; and determining the TAG ID at least based on a mapping between flag index values and TAG ID index values.

In a fourth aspect, there is provide a method. The method comprises transmitting, from a network device and to the terminal device and during the random access procedure, a flag mappable to a timing advance group identity, TAG ID associated with a serving cell of the network device, wherein the terminal device is configured with two TAGs associated with the serving cell and the TAG ID is associated with one of the two TAGs.

In a fifth aspect, there is provided an apparatus comprising means for receiving, during the random access procedure, a flag mappable to a timing advance group identity, TAG ID, associated with a serving cell of the apparatus, wherein the apparatus is configured with two TAGs associated with the serving cell and the TAG ID is associated with one of the two TAGs; and means for determining the TAG ID at least based on a mapping between flag index values and TAG ID index values.

In a sixth aspect, there is provided an apparatus comprising means for transmitting, to the terminal device and during the random access procedure, a flag mappable to a timing advance group identity, TAG ID associated with a serving cell of the apparatus, wherein the terminal device is configured with two TAGs associated with the serving cell and the TAG ID is associated with one of the two TAGs.

In a seventh aspect, there is provided a computer readable medium having a computer program stored thereon which, when executed by at least one processor of an apparatus, causes the apparatus to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating an example of process according to some example embodiments of the present disclosure;

FIG. 3 shows an example of message format in which the flag for indicating the TAG may be included according to some example embodiments of the present disclosure;

FIG. 4 shows a flowchart of an example method of indicating a TAG according to some example embodiments of the present disclosure;

FIG. 5 shows a flowchart of an example method of indicating a TAG according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), an Enhanced Machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, low earth orbit (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “transmission reception point (TRP)” may refer to an antenna port or an antenna array (with one or more antenna elements) available to the network device located at a specific geographical location. For example, a network device may be coupled with multiple TRPs in different geographical locations to achieve better coverage. Alternatively, or in addition, multiple TRPs may be incorporated into a network device, or in other words, the network device may comprise the multiple TRPs. The term “TRP” may be also referred to as a cell, such as a macro-cell, a small cell, a pico-cell, a femto-cell, a remote radio head, a relay node, etc. It is to be understood that the term “TRP” may refer to a logical concept which may be physically implemented by various manner. For example, a TRP may refer to or correspond to a physical cell identity (PCI) or control resource set (CORESET) Pool Index (i.e., CORESETPoolIndex). In example embodiments of the present disclosure, the term “TRP” can be used interchangeably with the terms “PCI” or “CORESETPoolIndex”.

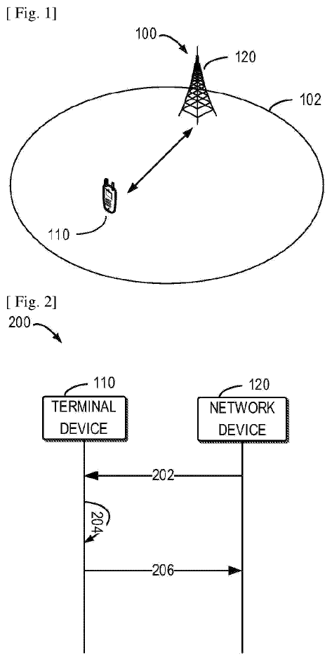

FIG. 1 shows an example communication network 100 in which embodiments of the present disclosure may be implemented. As shown in FIG. 1, the communication network 100 may include a terminal device 110. Hereinafter the terminal device 110 may also be referred to as a UE.

The communication network 100 may further a network device 120 providing a serving cell 102 of the terminal device. The terminal device 110 may communicate with the network device 120 within the coverage of the serving cell 102.

In some scenario, a serving cell may be configured with multi-TRPs (MTRP), for a first TRP and a second TRP. When the terminal device 110 communicates with the network device 120 within the serving cell 102, the terminal device 110 may communicate with the one of or both the first TRP and the second TRP. For example, the terminal device may be allowed to transmit and/or receive control information and data from the first TRP and the second TRP.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As discussed above, MIMO has been widely used in current wireless communication system. Specifically, MIMO is one of the key technologies in the NR systems and is successful in commercial deployment. In release-15/16/17 of 3GPP, MIMO features were investigated and specified for both frequency division duplexing (FDD) and time division duplexing (TDD) systems, of which major parts were for downlink MIMO operation.

In release-18 of 3GPP, it is important to identify and specify necessary enhancements for uplink MIMO, while necessary enhancements on downlink MIMO that facilitate the use of large antenna array, not only for frequency range (FR) 1 but also for FR2, would still need to be introduced to fulfil the request for evolution of NR deployments. This comprises the following areas of enhancement.

First, significant loss of performance for a UE at high/medium speed has been observed in commercial deployments especially in multi-user MIMO (MU-MIMO) scenarios. As the performance loss is partly caused by outdated channel state information (CSI), enhancements on CSI acquisition to alleviate such loss can be beneficial.

Second, the unified transmission configuration indicator (TCI) framework was introduced in release-17 which facilitates streamlined multi-beam operation targeting FR2. As release-17 focuses on single-TRP use cases, extension of unified TCI framework that focuses on multi-TRP use cases is beneficial.

Third, due to the increasing need for multiplexing capacity of downlink and uplink demodulation reference signal (DMRS) from various use cases, there is a need for increasing the number of orthogonal ports for DMRS.

Fourth, features for facilitating multi-TRP deployments have been introduced in Release 16/17 focusing on non-coherent joint transmission (NC-JT). As coherent joint transmission (CJT) improves coverage and average throughput in commercial deployments with high-performance backhaul and synchronization, enhancement on CSI acquisition for FDD and TDD, targeting FR1, can be beneficial in expanding the utility of multi-TRP deployments.

Fifth, as advanced UEs (for example, CPE, fixed wireless access (FWA), vehicle, industrial devices) become more relevant, introducing necessary enhancements to support for 8 antenna ports as well as 4 and more layers for uplink (UL) transmission can offer the needed improvement for UL coverage and average throughput.

Sixth, with the introduction of features for UL panel selection in Release 17, advanced UEs (for example, CPE, FWA, vehicle, industrial devices) can benefit from higher UL coverage and average throughput with simultaneous UL multi-panel transmission. Finally, some further enhancement to facilitate UL multi-TRP deployments via two TAs and enhanced UL power control can offer additional UL performance improvement.

Further, in release 18, more enhancements for multi-TRP scenario are expected. In one example, it is expected to study CSI reporting enhancement for high/medium UE velocities by exploiting time-domain correlation/Doppler-domain information to assist DL precoding, targeting FR1, as follows: release-16/17 Type-II codebook refinement, without modification to the spatial and frequency domain basis; and UE reporting of time-domain channel properties measured via CSI-RS for tracking.

In another example, it is expected to study extension of Release 17 Unified TCI framework for indication of multiple DL and UL TCI states focusing on multi-TRP use case, using Release 17 unified TCI framework.

In a further example, it is expected to study larger number of orthogonal DMRS ports for downlink and uplink MU-MIMO (without increasing the DM-RS overhead), only for CP-OFDM. Specifically, strive for a common design between DL and UL DMRS, and support up to 24 orthogonal DM-RS ports, where for each applicable DMRS type, the maximum number of orthogonal ports is doubled for both single- and double-symbol DMRS.

In a further example, it is expected to study enhancements of CSI acquisition for CJT targeting FR1 and up to 4 TRPs, assuming ideal backhaul and synchronization as well as the same number of antenna ports across TRPs, as follows:

release 16/17 Type-II codebook refinement for CJT multi-TRP targeting FDD and its associated CSI reporting, taking into account throughput-overhead trade-off.

SRS enhancement to manage inter-TRP cross-SRS interference targeting TDD CJT via SRS capacity enhancement and/or interference randomization, with the constraints that 1) without consuming additional resources for SRS; 2) reuse existing SRS comb structure; 3) without new SRS root sequences.

Further, the maximum number of CSI-RS ports per resource remains the same as in Release 17, i.e., 32.

In a further example, it is expected to study UL DMRS, SRS, SRI, and transmit precoding matrix indicator (TPMI) (including codebook) enhancements to enable 8 Tx UL operation to support 4 and more layers per UE in UL targeting CPE/FWA/vehicle/Industrial devices.

In a further example, it is expected to study the following items to facilitate simultaneous multi-panel UL transmission for higher UL throughput/reliability, focusing on FR2 and multi-TRP, assuming up to 2 TRPs and up to 2 panels, targeting CPE/FWA/vehicle/industrial devices (if applicable):

UL precoding indication for PUSCH, where no new codebook is introduced for multi-panel simultaneous transmission. The total number of layers is up to four across all panels and total number of codewords is up to two across all panels, considering single DCI and multi-DCI based multi-TRP operation.

UL beam indication for physical uplink control channel (PUCCH)/physical uplink shared channel (PUSCH), where unified TCI framework extension is expected, considering single downlink control information (DCI) and multi-DCI based multi-TRP operation. For the case of multi-DCI based multi-TRP operation, only for a combination of PUSCH and PUSCH, or a combination PUCCH and PUCCH is transmitted across two panels in a same component carrier (CC).

In a further example, it is expected to Study, and if justified, specify the following: Two TAs for UL multi-DCI for multi-TRP operation, power control for UL single DCI for multi-TRP operation where unified TCI framework extension in objective 2 is assumed.

In summary, operations under the multi-TRP scenario are technical focus. In this present disclosure, a solution of related transmissions is proposed for a scenario where the at least two TA values are configured for a UE within a serving cell. Some related-technical implementations are listed as below.

In some embodiments, enhancement on two TAs for UL multi-DCI for multi-TRP operation is supported. Further, the network may signal two TACs or the network may signal one TAC and the UE may derives the second TA.

In some embodiments, support two TA enhancement for both intra-cell and inter-cell multi-DCI multi-TRP scenarios. Further, enhancements on two TAs for UL multi-DCI for multi-TRP operation are applicable to both FR1 and FR2.

In some embodiments, Two TA enhancement for uplink multi-DCI based multi-TRP operation are applicable to at least: TDM based multi-DCI uplink transmission, simultaneous multi-DCI uplink transmission (if simultaneous uplink multi-DCI uplink transmission is supported).

In some embodiments, for multi-DCI multi-TRP operation with two TAs, it is expected to study the following alternatives: considering two reference timings (i.e., timing of the DL reception), considering one reference timing.

In some embodiments, for multi-DCI multi-TRP operation with two TAs, any the following alternatives may be supported: one n-TimingAdvanceOffset value per serving cell, or two n-TimingAdvanceOffset value per serving cell.

In some embodiments, for multi-DCI based multi-TRP operation, down-select one of the two alternatives: configure two TAGs within a serving cell, or consider two TAs within one TAG within a serving cell.

In some embodiments, for multi-DCI based multi-TRP operation with two TAs, as for the overlapping part between two UL transmissions associated with two TAs, several solutions may be used, including introducing scheduling restriction in overlapping part, introducing dropping rules, and allowing overlapped transmission in case the UE supports STxMP transmission.

In some embodiments, for multi-DCI based multi-TRP operation with two TAs, two TAGs belonging to a serving cell may be configured.

In some embodiments, for multi-DCI multi-TRP operation with two TAs, up to two n-TimingAdvanceOffset value per serving cell may be supported.

In some embodiments, the multi-DCI based multi-TRP operation with two TAs may applicably for the following: RACH triggered by Physical Downlink Control Channel (PDCCH) order in intra-cell MTRP case, RACH triggered by PDCCH order in inter-cell MTRP case, UE triggered RACH by contention-based RA (CBRA) or contention free (CFRA) in radio resource control (RRC) connected mode.

In some embodiments, for associating TAGs to target UL channels/signals for multi-DCI based multi-TRP operation, downselect one of the options:
option 1: associate TAG to TCI-state/spatial relation;
option 2: associate TAG to CORESETPoolIndex;
option 3: associate TAG to DL reference signal (RS) group. For a UL transmission, UE adopts the TAG associated with the DL RS group to which the PL RS of the UL transmission belongs;
option 4: associate TAG to target UL channels/RSs directly for semi-static UL channels/RSs (e.g. periodic CSI PUCCH, periodic SRS, configured grant (CG) PUSCH), and further discuss how to associate TAG to dynamic UL channels/RSs (e.g. via associating TAG to CORESETPoolIndex additionally, etc.).

In some embodiments, for multi-DCI multi-TRP operation with two TAs in a CC, two DL reference timings are supported where each DL reference timing is associated with one TAG. Further, the baseline assumption is that the Rx timing difference between the two DL reference timings is no larger than CP length, and as an optional UE capability, Rx timing difference between the two DL reference timings can be assumed to be larger than CP length.

In some embodiments, for inter-cell multi-DCI based multi-TRP operation with two TA enhancement, support one of the options: physical downlink control channel (PDCCH) scheduling RAR will always be received from serving cell è there is no need for additional type 1 common Search Space (CSS) configuration per additional PCI; and in addition to PDCCH scheduling random access response (RAR) being received from serving cell, reception of PDCCH scheduling RAR from a TRP corresponding to an additional PCI for a RACH procedure associated to the additional PCI is supported è additional type 1 CSS configuration per additional PCI needs to be supported.

In some embodiments, for multi-DCI based inter-cell multi-TRP operation with two TA enhancement, support physical random access channel (PRACH) configuration associated with additional configured PCIs different from the PCI of the serving cell.

In some embodiments, for multi-DCI based inter-cell multi-TRP operation with two TA enhancement, support a mechanism to determine which PRACH configuration (i.e., RACH configuration corresponding to serving cell PCI or an additional PCI) to be used in the RACH procedure triggered by PDCCH order.

In some embodiments, for multi-DCI based multi-TRP operation with two TA enhancement, support one of the following: 1) PDCCH order sent by one TRP triggers RACH procedure towards the same TRP, where PDCCH order sent by one TRP triggering RACH procedure towards another TRP is not allowed; 2) Alt 2: PDCCH order sent by one TRP triggers RACH procedure towards either the same TRP or a different TRP, where PDCCH order triggering two RACH procedures for two TRPs may be further supported.

In some embodiments, for associating TAGs to target UL channels/signals for multi-DCI based multi-TRP operation, the four options are refined as below:
option 1: associate TAG to TCI-state/spatial relation. Further, configure TAG identification (ID) as part of UL/joint TCI state or spatial relation, and for UL transmission, the TAG ID associated with the UL/joint TCI state or spatial relation is utilized.
option 2: associate TAG to CORESETPoolIndex. Further, for dynamically scheduled/activated PUSCH, TAG associated with the CORESET pool index of the CORESET carrying the scheduling/activating PDCCH is utilized for UL transmission. Specifically, for Type 1 CG, P/SP-SRS, and P/SP-PUCCH, CORESET pool index is RRC-configured.
option 3: associate TAG to SSB group. For a UL transmission, UE adopts the TAG associated with the SSB group such that if the PL RS is an SSB, then the UE adopts the TAG associated with the SSB group which the path loss (PL) RS of the UL transmission belongs to, and if the PL RS is a CSI-RS, then the UE adopts the TAG associated with the SSB group which the QCL source SSB of the PL RS belongs to.
option 4: TAG association performed as follows: for dynamically scheduled/activated channels/signals, TAG associated with the CORESET pool index of the CORESET carrying the scheduling PDCCH is utilized for UL transmission; for P/SP UL channels/signals (not scheduled or activated by DCI), TAG ID is RRC-configured.

In some embodiments, for multi-DCI based multi-TRP operation with two TA enhancement, support enhancements related to indicating TAG ID via absolute TA command.

In some embodiments, for multi-DCI based Multi-TRP operation with two TA enhancement, it cannot always be assumed that both TRPs have knowledge of the overlapping region between transmissions corresponding to the two TAs. Further the network may apply scheduling restrictions even if the TRPs have no knowledge of the overlapping region.

In some embodiments, for intra-cell multi-DCI based Multi-TRP operation with two TA enhancement, support at least one of the following options:
option 1: indicate TAG ID as part of TA command in RAR;
option 2: indicate TAG ID as part of PDCCH order;
option 3: divide SSBs into two groups, one for each TRP. If a SSB associated to a RACH procedure belongs to the nth group (n=1, 2), then the TA obtained via the RACH procedure corresponds to the nth TRP;
option 4: divide RACH resources into two groups, where for a RACH procedure, if the corresponding RACH resource belongs to the nth group (n=1, 2), then the TA obtained via the RACH procedure corresponds to the nth TRP;
option 5: divide preambles into two groups, where for a RACH procedure, if the corresponding preamble belongs to the nth group (n=1, 2), then the TA obtained via the RACH procedure corresponds to the nth TRP;
option 6: TAG ID is associated with CORESETPoolIndex and TAG ID is determined based on the CORESETPoolIndex of PDCCH order;
option 7: each TCI state is associated with a TAG ID, and the TAG ID corresponding to RACH triggered by a PDCCH order is determined based on the TCI state used to receive the PDCCH order.

In some embodiments, for multi-DCI based inter-cell multi-TRP operation with two TA enhancement, one additional PRACH configuration is supported for each configured additional PCI. Further, the additional PRACH configuration is used in a RACH procedure triggered by a PDCCH order for the corresponding configured additional PCI.

In some embodiments, for multi-DCI based multi-TRP operation with two TA enhancement, support CFRA triggered by PDCCH order for both intra-cell and inter-cell cases.

In some embodiments, for multi-DCI based multi-TRP operation with two TA enhancement, support the case where a PDCCH order sent by one TRP triggers RACH procedure towards either the same TRP or a different TRP at least for inter-cell multi-DCI.

In some embodiments, for multi-DCI based multi-TRP operation with two TA enhancement, there is no consensus to support enhancements for CBRA triggered by PDCCH order.

In some embodiments, for associating TAGs to target UL channels/signals for multi-DCI based multi-TRP operation, support the following: associate TAG to TCI-state; associate TAG ID with UL/joint TCI state; for UL transmission, the TAG ID associated with the UL/joint TCI state is utilized; a baseline is UE expects that the (activated) UL/joint TCI states (of UL signals/channels) associated to one CORESET Pool Index correspond to one TAG; a UE may report that it supports that the (activated) UL/joint TCI states (of UL signals/channels) associated to one CORESETPoolIndex correspond to both TAGs.

In some embodiments, for multi-DCI based inter-cell multi-TRP operation with two TA enhancement, one additional PRACH configuration is supported for each configured additional PCI, and the additional PRACH configuration is used in a RACH procedure triggered by a PDCCH order for the corresponding configured additional PCI.

In some embodiments, for multi-DCI based multi-TRP operation with two TA enhancement, for the case when the UE does not support UL STxMP transmission, down-select at least one of the following:
introducing a time gap X between two UL transmissions associated with two different TA values, where X symbols in the slot(s) corresponding to the two UL transmission remain unused;
reduce the overlapping duration of one of the two UL transmissions;
scheduling restriction is applied such that the UE does not expect the two UL transmissions to overlap.

Basically, two CBRA procedures are supported, namely 4-step random access procedure (i.e., RACH) and 2-step random access procedure.

For example, during a 4-step RACH, a UE may send a specific preamble in a Message 1 (MSG1) to the gNB via a physical random access channel (PRACH) using a specific resource called RACH occasion (RO). The gNB may reply with a random access response (RAR) message, which may also be called as Message 2 (MSG2). The MSG2 may include the detected preamble ID, the time-advance command, a Temporary Cell-Radio Network Temporary Identifier (TC-RNTI) and UL grant for the transmission of MSG3 on Physical Uplink Shared Channel (PUSCH). Then the UE may respond to MSG2 over the scheduled PUSCH with an ID for contention resolution for a Radio Resource Control (RRC) request, which may also be called as MSG3. The gNB may transmits the contention resolution message with the contention-resolution ID for a RRC setup, which may also be referred to as a Message 4 (MSG4).

Upon reception of the MSG4, the UE may send an ACK on a Physical Uplink Control Channel (PUCCH) if its contention-resolution ID is carried by MSG4. This completes the 4-step RACH. Furthermore, prior to MSG1, there is also a preliminary step of sending (at gNB) and receiving (at UE) the synchronization signal block (SSB), comprising DL beam sweeping, which is not formally part of the RACH procedure. As a result of this preliminary step, the UE may select the index of the preferred SSB beam and decode the associated Physical Broadcast Channel (PBCH) for Master Information Block (MIB), System Information Block (SIB) and so on. This index is also used by UE to identify a suitable RO for the preamble transmission (i.e., MSG1), according to the SSB-to-RO mapping conveyed by SIB1. The gNB may use the SSB beam index selected by the UE for the MSG2 transmission.

In the 2-step random access procedure, MSG1 and MSG3 are combined in a MSGA and sent out without waiting for feedback from the gNB in between (traditionally MSG2). Similarly, the gNB may combine MSG2 and MSG4 into Message B (MSGB).

Contention resolution for 4-step and 2-step RA procedures are specified, wherein the MSGB reception and contention resolution for 2-step RA type are specified as below.

In some embodiments, once the MSGA preamble is transmitted, regardless of the possible occurrence of a measurement gap, the MAC entity shall start the msgB-Response Window at the PDCCH occasion.

In some embodiments, once the MSGA preamble is transmitted, regardless of the possible occurrence of a measurement gap, the MAC entity shall monitor the PDCCH of the SpCell for a Random Access Response identified by MSGB-RNTI while the msgB-Response Window is running.

In some embodiments, once the MSGA preamble is transmitted, regardless of the possible occurrence of a measurement gap, if C-RNTI MAC CE was included in the MSGA, the MAC entity shall monitor the PDCCH of the SpCell for Random Access Response identified by the C-RNTI while the msgB-Response Window is running.

In some embodiments, once the MSGA preamble is transmitted, regardless of the possible occurrence of a measurement gap, if notification of a reception of a PDCCH transmission of the SpCell is received from lower layers, and if the C-RNTI MAC CE was included in MSGA, the MAC entity shall: consider this Random Access Response reception successful, stop the msgB-ResponseWindow, and consider this Random Access procedure successfully completed, if the Random Access procedure was initiated for SpCell beam failure recovery or for beam failure recovery of both BFD-RS sets of SpCell and the PDCCH transmission is addressed to the C-RNTI; else if the timeAlignmentTimer associated with the PTAG is running.

In some embodiments, once the MSGA preamble is transmitted, regardless of the possible occurrence of a measurement gap, if notification of a reception of a PDCCH transmission of the SpCell is received from lower layers, if the C-RNTI MAC CE was included in MSGA, and if CG-SDT procedure is ongoing and cg-SDT-TimeAlignmentTimer is running, the MAC entity shall: consider this Random Access Response reception successful, stop the msgB-Response Window, consider this Random Access procedure successfully completed, if the PDCCH transmission is addressed to the C-RNTI and contains a UL grant for a new transmission.

In some embodiments, once the MSGA preamble is transmitted, regardless of the possible occurrence of a measurement gap, if notification of a reception of a PDCCH transmission of the SpCell is received from lower layers, if the C-RNTI MAC CE was included in MSGA, and if a downlink assignment has been received on the PDCCH for the C-RNTI and the received TB is successfully decoded, the MAC entity shall: process the received Timing Advance Command, consider this Random Access Response reception successful, stop the msgB-ResponseWindow, and consider this Random Access procedure successfully completed and finish the disassembly and demultiplexing of the MAC PDU, if the MAC PDU contains the Absolute Timing Advance Command MAC CE.

In some embodiments, once MSG3 is transmitted, if the MSG3 transmission (i.e. initial transmission or HARQ retransmission) is scheduled with Type A PUSCH repetition, the MAC entity shall: start or restart the ra-ContentionResolution Timer in the first symbol after the end of all repetitions of the MSG3 transmission plus the UE-gNB RTT, if MSG3 is transmitted on a non-terrestrial network; else start or restart the ra-ContentionResolutionTimer in the first symbol after the end of all repetitions of the MSG3 transmission.

In some embodiments, once MSG3 is transmitted, if MSG3 transmission (i.e., initial transmission or HARQ retransmission) is transmitted on a non-terrestrial network, the MAC entity shall: start or restart the ra-ContentionResolutionTimer in the first symbol after the end of the MSG3 transmission plus the UE-gNB RTT.

In some embodiments, once MSG3 is transmitted, if the MSG3 transmission (i.e. initial transmission or HARQ retransmission) is not scheduled with Type A PUSCH repetition and MSG3 transmission (i.e. initial transmission or HARQ retransmission) is not transmitted on a non-terrestrial network, the MAC entity shall start or restart the ra-ContentionResolutionTimer in the first symbol after the end of the MSG3 transmission.

In some embodiments, once MSG3 is transmitted the MAC entity shall monitor the PDCCH while the ra-ContentionResolutionTimer is running regardless of the possible occurrence of a measurement gap.

In some embodiments, once MSG3 is transmitted, if notification of a reception of a PDCCH transmission of the SpCell is received from lower layers and if the C-RNTI MAC CE was included in MSG3, the MAC entity shall: consider this Contention Resolution successful, stop ra-ContentionResolutionTimer, discard the TEMPORARY_C-RNTI, and consider this Random Access procedure successfully completed, if the Random Access procedure was initiated for SpCell beam failure recovery or for beam failure recovery of both BFD-RS sets of SpCell and the PDCCH transmission is addressed to the C-RNTI, or if the Random Access procedure was initiated by a PDCCH order and the PDCCH transmission is addressed to the C-RNTI, or if the Random Access procedure was initiated by the MAC sublayer itself or by the RRC sublayer and the PDCCH transmission is addressed to the C-RNTI and contains a UL grant for a new transmission.

As described above, the enhancement on two TAs for UL multi-DCI for multi-TRP operation is expected to be further discussed and developed in Release 18. Since currently the TAG ID space is 4 and if that is extended to, e.g., 8 TAG IDs as a result of the mTRP work, how to indicate the TAG ID in the random access procedure may still need to be discussed.

The solution of the present disclosure proposes a mechanism for indicating a TAG. In this solution, during a random access procedure, in a case where the terminal device 100 is configured with two TAGs associated with a serving cell of the terminal device, the network device may transmit, to the terminal device, a flag mappable to a TAG ID associated with the serving cell and the TAG ID is associated with one of the two TAGs. Then the terminal device 110 may determine the TAG ID at least based on a mapping between flag index values and TAG ID index values.

In this way, TAG ID for a serving cell can be indicated with a one-bit flag which can indicate information about TAG ID with a lower overhead. Further, the flag may be included in RAR/MSGB/fallbackRAR with a lower overhead also to DCI/UL grant.

Example embodiments of the present disclosure will be described in detail below with reference to the accompanying drawings.

Reference is now made to FIG. 2, which shows a signaling chart 200 for communication according to some example embodiments of the present disclosure. As shown in FIG. 2, the signaling chart 200 involves the terminal device 110 and the network device 120. For the purpose of discussion, reference is made to FIG. 1 to describe the signaling chart 200.

In a scenario related to FIG. 2, a serving cell 102 managed by the network device 120 may serve the terminal device 110. The terminal device 110 may be configured with two TAGs associated with the serving cell 102.

As shown in FIG. 2, the network device 120 may transmit (202) a flag mappable to a TAG ID associated with the serving cell.

In some embodiments, the flag is introduced to indicate between TAG IDs (e.g., two TAG IDs) associated with the serving cell 102 where the PRACH preamble is transmitted (for example in MSG 1). That is, the flag may indicate which TAG ID the transmitted PRACH preamble corresponds to within the serving cell where the PRACH preamble is transmitted.

For example, the flag may be a one-bit indication. That is, the flag serves as a one-bit flag. Since currently the TAG ID may occupy 2 bits (4 indices/values) which may be extended to a larger value (e.g., 8) due to the multi-TRPs work, a single reserved bit could not indicate the exact TAG ID. Therefore, the one-bit flag can be used to indicate whether a TAG ID of the serving cell having a certain index value.

In some embodiments, the flag indicating a first value may be mappable to a TAG ID having a lowest index value in TAG IDs associated with the serving cell, and the flag indicating a second value may be mappable to a TAG ID having a lowest index value in TAG IDs associated with the serving cell.

For example, the lowest index of the flag (i.e., ‘0’) may correspond to TAG ID of the serving cell with lower index value (e.g., ‘0’, ‘1’, or ‘2’, etc.) while the highest index of the flag (i.e., ‘1’) may correspond to the TAG ID of the serving cell with higher index value (e.g., ‘1’, ‘2’, or ‘3’), or vice versa.

In some embodiments, the flag is indicated in a RAR or a Message B. Alternatively, the RAR herein used may also be referred to as a fallback RAR.

In some embodiments, the flag is indicated in a reserved bit in the RAR or the Message B. For example, the one-bit flag may replace a reserved bit in the RAR or MSGB.

In some embodiments, the flag is included in a UL grant field of the Medium Access Control (MAC) payload for RAR. For example, the one-bit flag may be indicated by the first bit of the MAC payload for RAR, or the first bit of the MAC payload for Message B.

In some embodiments, the flag is included in downlink control information (DCI) for scheduling the RAR or MSGB. For example, the flag is included in DCI for scheduling a MAC Protocol Data Unit (PDU) for a RAR, or a MAC PDU for Message B.

In this case, each RAR MAC PDU may be limited to indicate RARs which are associated with the same TRP (and hence, for each terminal device, RARs are associated to the TAG ID corresponding to this TRP).

In some other embodiments, the flag is included in DCI for scheduling a UL grant for a successful contention resolution or a successful random access procedure completion. In one example, the one-bit flag is included in the DCI scheduling UL grant used for successful contention resolution or successful RA procedure completion (i.e., “PDCCH transmission is addressed to the C-RNTI and contains a UL grant for a new transmission”) or DL assignment (e.g., in case of Beam Failure recovery (BFR) or 2-step RA with absolute Timing Advance Command (TAC) MAC CE).

As shown in FIG. 2, the terminal device 110 may determine (204) the TAG ID to be used for the subsequent UL transmission based on the received flag and for example, an association between flag index values and index values of TAG ID. That is, the received flag may be mapped to an index value TAG ID based on the association.

Then the terminal device 110 may perform (204) subsequent UL transmission to the network device by using a timing advance corresponding to the TAG ID.

Based on the solution proposed in the present disclosure, a possible impact on the specification may be listed as below:

TABLE 1
6.2.3 MAC payload for Random Access Response

The MAC RAR is of fixed size as depicted in FIG. 6.2.3-1, and consists of the following fields:

| | |
|---|---|
| - | TI: The TI field indicates TAG ID the transmitted PRACH preamble corresponds to within the |
| | Serving Cell where the MAC entity initiated the transmission of the PRACH preamble. TI field set |
| | to 0 corresponds to the TAG ID with lower index value configured for the Serving Cell; TI field set |
| | to 1 corresponds to the TAG ID with higher index value configured for the Serving Cell. If the |
| | Serving Cell is not associated with multiple TAG IDs. MAC entity shall ignore the TI field; |
| - | Timing Advance Command: The Timing Advance Command field indicates the index value T_{A} used |
| | to control the amount of timing adjustment that the MAC entity has to apply in TS 38.213 [6]. The |
| | size of the Timing Advance Command field is 12 bits; |
| - | UL Grant: The Uplink Grant field indicates the resources to be used on the uplink in TS 38.213 [6]. |
| | The size of the UL Grant field is 27 bits; |
| - | Temporary C-RNTI: The Temporary C-RNTI field indicates the temporary identity that is used by |
| | the MAC entity during Random Access. The size of the Temporary C-RNTI field is 16 bits. |

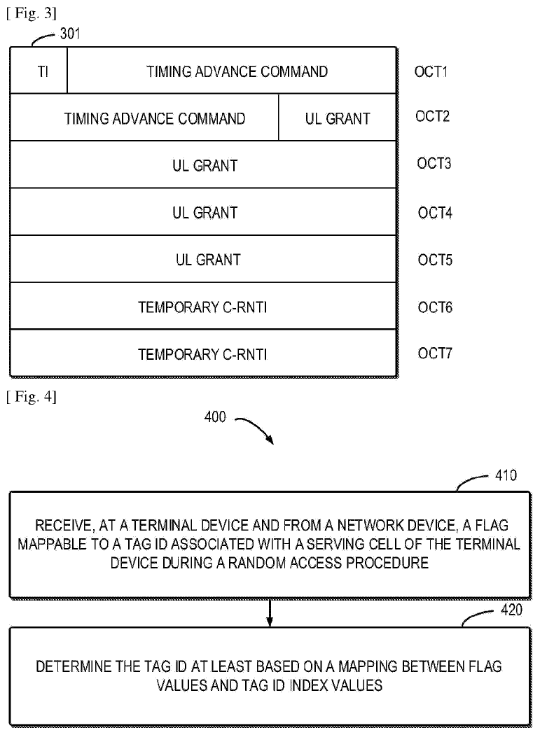

FIG. 3 shows an example of message format in which the flag for indicating the TAG may be included according to some example embodiments of the present disclosure.

In some embodiments, the flag mappable to a TAG ID may be included in the TI field 301 of a MAC payload for RAR. For example, the lowest index of the flag (i.e., ‘0’) may correspond to TAG ID of the serving cell with lower index value (e.g., ‘0’, ‘1’, or ‘2’, etc.) while the highest index of the flag (i.e., ‘1’) may correspond to the TAG ID of the serving cell with higher index value (e.g., ‘1’, ‘2’, or ‘3’).

In some embodiments, the flag mappable to a TAG ID may be included in the UL grant field of a MAC payload for RAR.

FIG. 4 shows a flowchart of an example method 400 of indicating a TAG according to some example embodiments of the present disclosure. The method 400 may be implemented at the terminal device 110 as shown in FIG. 1. For the purpose of discussion, the method 400 will be described with reference to FIG. 1.

At 410, the terminal device 110 receives, during the random access procedure, a flag mappable to a timing advance group identity, TAG ID, associated with a serving cell of the apparatus, wherein the apparatus is configured with two TAGs associated with the serving cell and the TAG ID is associated with one of the two TAGs.

At 420, the terminal device 110 determines the TAG ID at least based on a mapping between flag index values and TAG ID index values.

In some example embodiments, the flag is a one-bit indication.

In some example embodiments, the flag indicating a first value is mappable to a TAG ID having a lowest index value in TAG IDs associated with the serving cell, and the flag indicating a second value is mappable to a TAG ID having a lowest index value in TAG IDs associated with the serving cell.

In some example embodiments, the flag is indicated in a Random Access Response, RAR, or a Message B.

In some example embodiments, the flag is included the flag is indicated by the first bit of the Medium Access Control, MAC, payload for RAR, or the first bit of the MAC payload for Message B.

In some example embodiments, the flag is included in an uplink grant field in a Random Access Response, RAR.

In some example embodiments, the flag is included in downlink control information, DCI, for scheduling a Medium Access Control, MAC, Protocol Data Unit, PDU, for a Random Access Response, RAR, or a MAC PDU for Message B.

In some example embodiments, the flag is included in downlink control information, DCI, for scheduling an uplink grant for a successful contention resolution or a successful random access procedure completion.

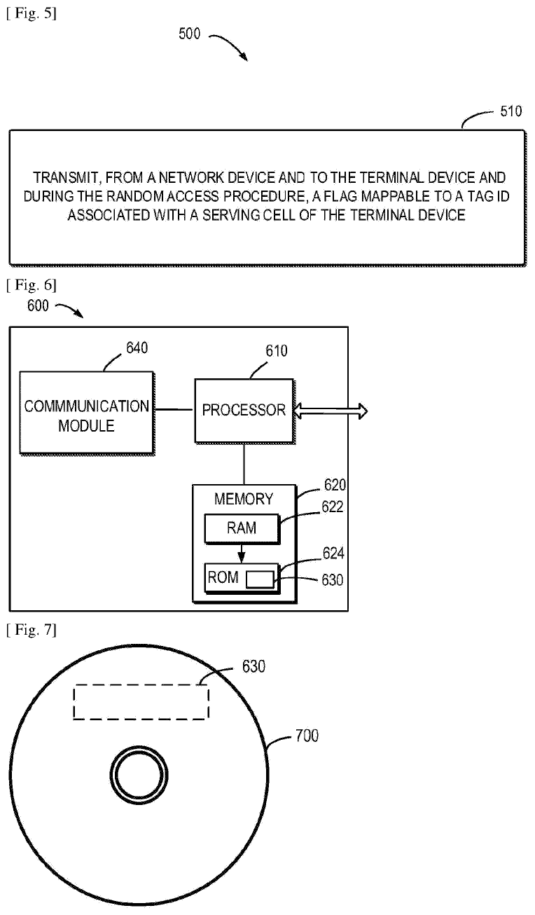

FIG. 5 shows a flowchart of an example method 500 of indicating a TAG according to some example embodiments of the present disclosure. The method 500 may be implemented at the network device 120 as shown in FIG. 1. For the purpose of discussion, the method 500 will be described with reference to FIG. 1.

At 510, the network device 120 transmits, to the terminal device and during the random access procedure, a flag mappable to a timing advance group identity, TAG ID associated with a serving cell of the apparatus, wherein the terminal device is configured with two TAGs associated with the serving cell and the TAG ID is associated with one of the two TAGs.

In some example embodiments, the flag is a one-bit indication.

In some example embodiments, the flag indicating a first value is mappable to a TAG ID having a lowest index value in TAG IDs associated with the serving cell, and the flag indicating a second value is mappable to a TAG ID having a lowest index value in TAG IDs associated with the serving cell.

In some example embodiments, the flag is indicated in a Random Access Response, RAR, or a Message B.

In some example embodiments, the flag is included the flag is indicated by the first bit of the Medium Access Control, MAC, payload for RAR, or the first bit of the MAC payload for Message B.

In some example embodiments, the flag is included in an uplink grant field in a Random Access Response, RAR.

In some example embodiments, the flag is included in downlink control information, DCI, for scheduling a Medium Access Control, MAC, Protocol Data Unit, PDU, for a Random Access Response, RAR, or a MAC PDU for Message B.

In some example embodiments, the flag is included in downlink control information, DCI, for scheduling an uplink grant for a successful contention resolution or a successful random access procedure completion.

In some example embodiments, an apparatus capable of performing the method 400 (for example, implemented at the terminal device 110) may include means for performing the respective steps of the method 400. The means may be implemented in any suitable form. For example, the means may be implemented in a circuitry or software module.

In some example embodiments, the apparatus comprises means for receiving, during the random access procedure, a flag mappable to a timing advance group identity, TAG ID, associated with a serving cell of the apparatus, wherein the apparatus is configured with two TAGs associated with the serving cell and the TAG ID is associated with one of the two TAGs; and means for determining the TAG ID at least based on a mapping between flag index values and TAG ID index values.

In some example embodiments, the flag is a one-bit indication.

In some example embodiments, the flag indicating a first value is mappable to a TAG ID having a lowest index value in TAG IDs associated with the serving cell, and the flag indicating a second value is mappable to a TAG ID having a lowest index value in TAG IDs associated with the serving cell.

In some example embodiments, the flag is indicated in a Random Access Response, RAR, or a Message B.

In some example embodiments, the flag is included the flag is indicated by the first bit of the Medium Access Control, MAC, payload for RAR, or the first bit of the MAC payload for Message B.

In some example embodiments, the flag is included in an uplink grant field in a Random Access Response, RAR.

In some example embodiments, the flag is included in downlink control information, DCI, for scheduling a Medium Access Control, MAC, Protocol Data Unit, PDU, for a Random Access Response, RAR, or a MAC PDU for Message B.

In some example embodiments, the flag is included in downlink control information, DCI, for scheduling an uplink grant for a successful contention resolution or a successful random access procedure completion.

In some example embodiments, an apparatus capable of performing the method 500 (for example, implemented at the TRP 120) may include means for performing the respective steps of the method 500. The means may be implemented in any suitable form. For example, the means may be implemented in a circuitry or software module.

In some example embodiments, the apparatus comprises means for transmitting, to the terminal device and during the random access procedure, a flag mappable to a timing advance group identity, TAG ID associated with a serving cell of the apparatus,
wherein the terminal device is configured with two TAGs associated with the serving cell and the TAG ID is associated with one of the two TAGs.

In some example embodiments, the flag is a one-bit indication.

In some example embodiments, the flag indicating a first value is mappable to a TAG ID having a lowest index value in TAG IDs associated with the serving cell, and the flag indicating a second value is mappable to a TAG ID having a lowest index value in TAG IDs associated with the serving cell.

In some example embodiments, the flag is indicated in a Random Access Response, RAR, or a Message B.

In some example embodiments, the flag is included the flag is indicated by the first bit of the Medium Access Control, MAC, payload for RAR, or the first bit of the MAC payload for Message B.

In some example embodiments, the flag is included in an uplink grant field in a Random Access Response, RAR.

In some example embodiments, the flag is included in downlink control information, DCI, for scheduling a Medium Access Control, MAC, Protocol Data Unit, PDU, for a Random Access Response, RAR, or a MAC PDU for Message B.

In some example embodiments, the flag is included in downlink control information, DCI, for scheduling an uplink grant for a successful contention resolution or a successful random access procedure completion.

FIG. 6 is a simplified block diagram of a device 600 that is suitable for implementing example embodiments of the present disclosure. The device 600 may be provided to implement a communication device, for example, the first terminal device 110 or the second terminal device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 6. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
receive, during a random access procedure, a flag mappable to a timing advance group identity, tag id, associated with a serving cell of the apparatus, wherein the apparatus is configured with two tags associated with the serving cell and the tag id is associated with one of the two tags; and
determine the tag id at least based on a mapping between flag index values and tag id index values.

2. The apparatus of claim 1, wherein the flag is a one-bit indication.

3. The apparatus of claim 1, wherein the flag indicating a first value is mappable to a tag id having a lowest index value in tag ids associated with the serving cell, and the flag indicating a second value is mappable to a tag id having a lowest index value in tag ids associated with the serving cell.

4. The apparatus of claim 1, wherein the flag is indicated in a random access response, rar, or a message b.

5. The apparatus of claim 4, wherein the flag is indicated by the first bit of the medium access control, mac, payload for rar, or the first bit of the mac payload for message b.

6. The apparatus of claim 1, wherein the flag is included in an uplink grant field in a random access response, rar.

7. The apparatus of claim 1, wherein the flag is included in downlink control information, dci, for scheduling a medium access control, mac, protocol data unit, pdu, for a random access response, rar, or a mac pdu for message b.

8. The apparatus of claim 1, wherein the flag is included in downlink control information, dci, for scheduling an uplink grant for a successful contention resolution or a successful random access procedure completion.

9. An apparatus comprising:
at least one processor; and
at least one memory storing instructions that, when executed by the at least one processor, cause the apparatus at least to:
transmit, to a terminal device and during a random access procedure, a flag mappable to a timing advance group identity, tag id associated with a serving cell of the terminal device, wherein the terminal device is configured with two tags associated with the serving cell and the tag id is associated with one of the two tags.

10. The apparatus of claim 9, wherein the flag is a one-bit indication.

11. The apparatus of claim 9, wherein the flag indicating a first value is mappable to a tag id having a lowest index value in tag ids associated with the serving cell, and the flag indicating a second value is mappable to a tag id having a lowest index value in tag ids associated with the serving cell.

12. The apparatus of claim 9, wherein the flag is indicated in a random access response, rar, or a message b.

13-16. (canceled)

17. A method comprising:
receiving, at a terminal device and from a network device, a flag mappable to a timing advance group identity, tag id, associated with a serving cell of the terminal device during a random access procedure, wherein the terminal device is configured with two tags associated with the serving cell and the tag id is associated with one of the two tags; and
determining the tag id at least based on a mapping between flag index values and tag id index values.

18-21. (canceled)

22. The method of claim 17, wherein the flag is a one-bit indication.

23. The method of claim 17, wherein the flag indicating a first value is mappable to a tag id having a lowest index value in tag ids associated with the serving cell, and the flag indicating a second value is mappable to a tag id having a lowest index value in tag ids associated with the serving cell.

24. The method of claim 17, wherein the flag is indicated in a random access response, rar, or a message b.

25. The method of claim 24, wherein the flag is indicated by the first bit of the medium access control, mac, payload for rar, or the first bit of the mac payload for message b.

26. The method of claim 17, wherein the flag is included in an uplink grant field in a random access response, rar.

27. The method of claim 17, wherein the flag is included in downlink control information, dci, for scheduling a medium access control, mac, protocol data unit, pdu, for a random access response, rar, or a mac pdu for message b.

28. The method of claim 17, wherein the flag is included in downlink control information, dci, for scheduling an uplink grant for a successful contention resolution or a successful random access procedure completion.
